(19) United States
(12) Patent Application Publication
(10) Pub. No.: US 2006/0086918 A1
(43) Pub. Date: Apr. 27, 2006

(54) Control valve for variable displacement compressor

(75) Inventor: Katsumi Koyama, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TGK CO., LTD., Tokyo (JP)

(21) Appl. No.: 11/251,906

(22) Filed: Oct. 18, 2005

(30) Foreign Application Priority Data
Oct. 22, 2004 (JP) 2004-308607

(51) Int. Cl. F16K 31/02; F25B 41/06

(52) U.S. Cl. 251/129.01; 62/527

(57) ABSTRACT

To provide a control valve for a variable displacement compressor, including a first control valve that controls the flow rate of refrigerant flowing from a discharge chamber into a crankcase, and a second control valve that controls the flow rate of refrigerant flowing from the crankcase into the suction chamber, wherein suction pressure is sensed, and pressure in the crankcase is controlled such that suction pressure is held constant, which control valve is simplified in construction of the first and second control valves. A port (Ps) at suction pressure is formed on a side of a port (Pd) at discharge pressure, toward a solenoid, and ports (Pc1) and (Pc2) leading to and from a crankcase are formed on an opposite side of the port (Pd) to the aforementioned side, and a hollow cylindrical member is disposed in a manner extending over these ports. The hollow cylindrical member functions as a valve element of a first control valve and a valve seat of a second control valve, whereby the first and second control valves are simplified in construction.

### CROSS-REFERENCES TO RELATED APPLICATIONS, IF ANY

This application claims priority of Japanese Application No. 2004-308607 filed on Oct. 22, 2004 and entitled “CONTROL VALVE FOR VARIABLE DISPLACEMENT COMPRESSOR”.

### BACKGROUND OF THE INVENTION

(1) Field of the Invention

The present invention relates to a control valve for a variable displacement compressor, and more particularly to a control valve for a variable displacement compressor which is suitable for controlling refrigerant displacement of a variable displacement compressor for an automotive air conditioner.

(2) Description of the Related Art

A compressor used in a refrigeration cycle of an automotive air conditioner is driven by an engine whose rotational speed is varied depending on a traveling condition of the vehicle, and hence is incapable of performing rotational speed control. For this reason, in general, a variable displacement compressor capable of changing refrigerant displacement is employed so as to obtain an adequate refrigerating capacity without being constrained by the rotational speed of the engine.

In the variable displacement compressor, in general, a wobble plate disposed within a crankcase formed gastight, such that the inclination angle thereof can be changed, is driven by the rotational motion of a rotating shaft, for performing wobbling motion, and pistons caused to perform reciprocating motion in a direction parallel to the rotating shaft by the wobbling motion of the wobble plate draw refrigerant from a suction chamber into associated cylinders, compress the refrigerant, and then discharge the same into a discharge chamber. In doing this, the inclination angle of the wobble plate can be varied by changing the pressure in the crankcase, whereby the stroke of the pistons is changed for changing the discharge amount of the refrigerant. The control valve for a variable displacement compressor provides control to change the pressure in the crankcase.

In general, such a control valve for a variable displacement compressor, which variably controls the displacement of the compressor, operates to introduce part of refrigerant at discharge pressure Pd discharged from the discharge chamber, into the crankcase formed gastight, such that pressure Pc in the crankcase is controlled through control of the amount of refrigerant thus introduced. One known method of controlling the amount of refrigerant introduced into the crankcase is, for example, to perform the control according to suction pressure Ps in the suction chamber. That is, the control valve senses suction pressure Ps, and controls the flow rate of refrigerant introduced from the discharge chamber into the crankcase at discharge pressure Pd, so as to hold suction pressure Ps at a constant level.

To this end, the control valve for a variable displacement compressor is equipped with a pressure-sensing section that senses suction pressure Ps, and a valve section that causes a passage leading from the discharge chamber to the crankcase to open and close according to suction pressure Ps sensed by the pressure-sensing section. Further, a type of the control valve for a variable displacement compressor which is capable of freely externally setting a value of suction pressure Ps to be assumed at the start of the variable displacement operation, is equipped with a solenoid that enables configuration of settings of the pressure-sensing section by external electric current.

By the way, conventional control valves for a variable displacement compressor which can be externally controlled include a type for control of a so-called clutchless variable displacement compressor configured such that an engine is directly connected to a rotating shaft without providing a solenoid clutch between the engine and the rotating shaft on which a wobble plate is fitted, for execution and inhibition of transmission of a driving force to the engine (see e.g. Japanese Unexamined Patent Publication (Kokai) No. 2001-107854 (Paragraph numbers [0035] and [0036], and FIG. 3)).

This control valve comprises a valve section that causes a passage communicating between a discharge chamber and a crankcase to be opened and closed, a solenoid that generates an electromagnetic force causing the valve section to operate in the closing direction, and a pressure-sensing section that causes the valve section to operate in the opening direction as suction pressure Ps becomes lower compared with the atmospheric pressure, which are arranged in this order. Therefore, when the solenoid is not energized, the valve section is in a fully open state, whereby pressure Pc in a crankcase can be held at a pressure close to discharge pressure Pd. This causes the wobble plate to become substantially at right angles to the rotating shaft, enabling the variable displacement compressor to operate at the minimum displacement. Thus, the refrigerant displacement can be substantially reduced to approximately zero even when the engine is directly connected to the rotating shaft, which makes it possible to eliminate the solenoid clutch.

Further, the present applicant has proposed a control valve for a clutchless variable displacement compressor, for controlling pressure Pc in a crankcase such that suction pressure Ps is maintained constant, wherein a change in the displacement of the compressor is made more responsive to a change in rotation of the compressor (Japanese Patent Application No. 2003-289581, FIGS. 5 and 13). This control valve comprises a first control valve that controls a flow rate of refrigerant introduced from a discharge chamber into a crankcase, and a second control valve that controls a flow rate of refrigerant delivered from the crankcase to a suction chamber, and is configured such that when one of the control valves operates in a valve opening direction, the other operates in a valve closing direction in a manner interlocked therewith, while when the one operates in a valve closing direction, the other operates in a valve opening direction in a manner interlocked therewith.

Further, this control valve has a construction which makes it unnecessary to consider pressure resistance of the entire solenoid in designing the same. That is, the control valve is configured such that a plunger as a component of the solenoid is divided into a first plunger and a second plunger, and a diaphragm is disposed between the divisional plungers, for sensing suction pressure Ps, the diaphragm isolating suction pressure Ps from the atmospheric pressure in which most part of the solenoid is disposed. With this configuration, when the solenoid is energized, the first plunger and the second plunger are attracted to each other to thereby behave as one plunger, and when the solenoid is not energized, the second plunger disposed on a side receiving suction pressure Ps is capable of maintaining the first control valve in a fully-open state, independently of the first plunger. Thus, the control valve serves as one for a clutchless variable displacement compressor.

However, the conventional control valve for a variable displacement compressor, including the first control valve that controls the flow rate of refrigerant flowing from the discharge chamber into the crankcase and the second control valve that controls the flow rate of refrigerant flowing from the crankcase into the suction chamber, wherein suction pressure Ps is sensed, and the pressure Pc in the crankcase of the compressor is controlled such that suction pressure Ps is held constant, suffers from the problem that the first and second control valves are each formed by a large number of components, and hence are complicated in construction.

### SUMMARY OF THE INVENTION

The present invention has been made in view of this problem, and an object thereof is to provide a control valve for a variable displacement compressor, including a first control valve that controls the flow rate of refrigerant flowing from a discharge chamber into a crankcase, and a second control valve that controls the flow rate of refrigerant flowing from the crankcase into the suction chamber, wherein suction pressure Ps is sensed, and pressure Pc in the crankcase of the compressor is controlled such that suction pressure Ps is held constant, which control valve is simplified in construction of the first and second control valves.

To solve the above problem, the present invention provides a control valve for a variable displacement compressor, including a first control valve that controls a flow rate of refrigerant flowing from a discharge chamber of the compressor to a crankcase of the compressor, a second control valve that controls a flow rate of refrigerant flowing from the crankcase to a suction chamber of the compressor, a pressure-sensing section that senses suction pressure in the suction chamber, and a solenoid that sets a set point of the pressure-sensing section by an external current supplied thereto, as desired, wherein the pressure-sensing section is disposed between a first plunger and a second plunger as divisional plungers of the solenoid, comprising a first port that receives discharge pressure from the discharge chamber, a second port that is disposed on a side of the first port opposite from the solenoid, for communication with the crankcase, a third port that is disposed on a side of the first port toward the solenoid, for communication with the suction chamber, and a hollow cylindrical member that is disposed in a manner such that the hollow cylindrical member is movable back and forth along an axis of the solenoid, the hollow cylindrical member having one end opening in the second port, and another end opening in the third port, an opening of the other end being opened and closed by the second plunger which is disposed between the hollow cylindrical member and the pressure-sensing section and is urged in a direction away from the pressure-sensing section, wherein the hollow cylindrical member is configured such that a refrigerant passage which is formed between the first port and the second port and through which extends the hollow cylindrical member, to form a valve hole, and a large-diameter portion of the hollow cylindrical member which is positioned within the second port and formed to have a larger outer diameter than an inner diameter of the refrigerant passage, form the first control valve, and an end face of the other end and the second plunger form the second control valve.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a central longitudinal cross-sectional view of the arrangement of a control valve for a variable displacement compressor, according to a first embodiment of the present invention.

FIG. 2 is a central longitudinal cross-sectional view of the control valve according to the first embodiment, in a state immediately after the start of energization of a solenoid.

FIG. 3 is a central longitudinal cross-sectional view of the control valve according to the first embodiment, in a state where a first control valve is fully closed.

FIG. 4 is a central longitudinal cross-sectional view of the control valve according to the first embodiment, in a state where a second control valve is fully opened.

FIG. 5 is a central longitudinal cross-sectional view of the arrangement of a control valve for a variable displacement compressor, according to a second embodiment of the present invention.

FIG. 6 is a central longitudinal cross-sectional view of the arrangement of a control valve for a variable displacement compressor, according to a third embodiment of the present invention.

### DESCRIPTION OF THE PREFERRED EMBODIMENTS

Hereinafter, embodiments of the present invention will be described in detail with reference to the drawings.

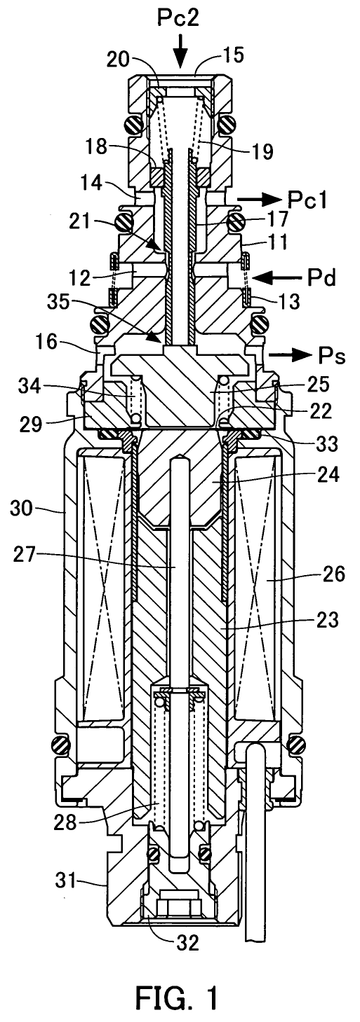

FIG. 1 is a central longitudinal cross-sectional view of the arrangement of a control valve for a variable displacement compressor, according to a first embodiment of the present invention.

This control valve comprises a valve section provided at an upper location, and a solenoid provided at a lower location, as viewed in FIG. 1. The valve section has a port 12 formed at a side of a central part of a body 11 in a vertical direction, for receiving discharge pressure Pd from a discharge chamber of the variable displacement compressor. On a portion of the body 11 where the port 12 opens, a strainer 13 is provided in a manner surrounding the port 12. The body 11 is also provided with a port 14 at an upper location than the part 12, as viewed in FIG. 1, for delivering controlled pressure Pc1 to a crankcase of the compressor, a port 15 at a top portion of the body 11 as viewed in FIG. 1, for introducing pressure Pc2 from the crankcase of the compressor, and a port 16 at a location lower than the port 12 as viewed in FIG. 1, for delivering pressure controlled to be suction pressure Ps to a suction chamber of the compressor.

The body 11 also has a through hole formed through a central portion thereof such that it is stepwise increased in inner diameter as it extends upward as viewed in FIG. 1, and inside the body 11, the port 15 at pressure Pc2, the port 14 at pressure Pc1, the port 12 at pressure Pd, and the port 16 at pressure Ps, which are formed in this order from the top side, as viewed in FIG. 1, are communicated with each other by the through hole. Particularly, a portion of the through hole between the port 14 at pressure Pc1 and the port 12 at discharge pressure Pd is formed to have a large diameter on a side toward the port 14, and a small diameter on a side toward the port 12. The small-diameter portion of the through hole has the same inner diameter as that of a portion of the through hole formed between the port 12 at discharge pressure Pd and the port 16 at suction pressure Ps.

Within the through hole, the hollow cylindrical member 17 is disposed in a manner axially movable back and forth. This hollow cylindrical member 17 has a lower part thereof, as viewed in FIG. 1, supported in the portion of the through hole, formed between the port 12 at discharge pressure Pd and the port 16 at suction pressure Ps, in a manner axially movable back and forth, with almost no clearance between the same and the body 11, and an upper part thereof, as viewed in FIG. 1, supported by a bearing 18 which is fixed within the port 15 at pressure Pc2 and separates the port 15 from the port 14 at pressure Pc1, in a manner axially movable back and forth. The hollow cylindrical member 17 is urged downward, as viewed in FIG. 1, by a spring 19 disposed within the port 15 at pressure Pc2, and the urging force thereof is adjusted by an adjustment screw 20 screwed into the port 15 at pressure Pc2.

The hollow cylindrical member 17 has an outer periphery thereof processed such that different axial portions thereof have respective various functions. More specifically, the lower part of the hollow cylindrical member 17, as viewed in FIG. 1, is formed to have an outer diameter which is approximately equal to the inner diameter of the portion of the through hole, formed between the port 12 at discharge pressure Pd and the port 16 at suction pressure Ps, and a part of the same positioned at a location corresponding to the location of the port 12 at discharge pressure Pd has a smaller outer diameter than the inner diameter of the small-diameter portion of the through hole, whereby a refrigerant passage is formed between the hollow cylindrical member 17 and the inner wall of the small-diameter portion of the through hole. The portion of the hollow cylindrical member 17 positioned at a location corresponding to the large-diameter portion of the through hole is formed to have a larger outer diameter than the inner diameter of the small-diameter portion of the through hole, and hence a stepped portion at the boundary between the small-diameter portion of the hollow cylindrical member 17 positioned at the location corresponding to the location of the port 12 at discharge pressure Pd and the large-diameter portion of the same positioned within the large-diameter portion of the through hole communicating with the port 14 at pressure Pc1 forms a valve element of the first control valve 21 that controls the flow rate of refrigerant flowing from the port 12 at discharge pressure Pd to the port 14 at pressure Pc1, and the small-diameter portion of the through hole forms a valve hole of the first control valve 21, with a stepped portion between the boundary of the small-diameter portion and the large-diameter portion of the through hole forming a valve seat of the first control valve 21. The hollow cylindrical member 17 further has a stopper circumferentially formed on the outer periphery thereof, for abutting the lower end face of the bearing 18, as viewed in FIG. 1, whereby the lift of the first control valve 21 in the fully-open state is limited.

The solenoid and a diaphragm 22 of the pressure-sensing section are provided below the body 11, as viewed in FIG. 1. The solenoid makes it possible to set a set point of pressure to be sensed by the diaphragm 22 by external current supplied thereto, as desired, and comprises a core 23, a first plunger 24 and a second plunger 25, a coil 26, a spring 28 urging the second plunger 25 in a direction away from the core 23 via a shaft 27 disposed in a manner extending through the core 23, and an annular member 29, a case 30, and a handle 31, which are made of a magnetic material and form a yoke. The shaft 27 has one end thereof fixed to the first plunger 24, and the other end thereof axially movably supported by an adjustment screw 32 screwed into the handle 31, for adjusting the load of the spring 28.

The diaphragm 22 is disposed between the first plunger 24 and the second plunger 25, and has an outer peripheral edge thereof sandwiched between the annular member 29 and the case 30, and a seal ring 33 isolates suction pressure Ps from the atmospheric pressure.

The second plunger 25 has a flange formed on a side thereof opposite from the diaphragm 22 such that the flange axially partially overlaps the annular member 29, and is urged upward, as viewed in FIG. 1, by a spring 34 interposed between the flange of the second plunger 25 and a flange of the annular member 29 extending inward along the diaphragm 22, while having the axial motion thereof guided by the same. The second plunger 25 also has a protrusion formed on a central part of the top thereof, as viewed in FIG. 1, such that the protrusion has a flat upper end face, and the urging force of the spring 34 brings the flat upper end face of the protrusion into contact with the lower end face of the hollow cylindrical member 17 projecting into a space communicating with the port 16 at suction pressure Ps. Here, the hollow cylindrical member 17 and the second plunger 25 form the second control valve 35 having a poppet valve structure, which controls the flow rate of refrigerant flowing from the port 15 at pressure Pc2 to the port 16 at suction pressure Ps. The lower end face of the hollow cylindrical member 17 forms a valve seat of the second control valve 35, while the protrusion in the central part of the top of the second plunger 25 forms a valve element of the second control valve 35.

The illustrated example of the control valve constructed as described above shows a state in which the solenoid is not energized. In this state, the first plunger 24 is urged by the spring 28 in a direction away from the core 23 to be brought into contact with the diaphragm 22. On the other hand, the second plunger 25 is urged by a spring 34 in a direction away from the diaphragm 22, and at the same time, pushes the hollow cylindrical member 17 upward, as viewed in FIG. 1, against the urging force of the spring 19 to a position where the stopper formed on the hollow cylindrical member 17 is brought into contact with the bearing 18. This causes the first control valve 21 to fully open, and the second control valve 35 to fully close, and what is more, the second plunger 25 pushing the hollow cylindrical member 17 upward is away from the diaphragm 22 which is displaced according to a change in suction pressure Ps, and hence is free from the influence of the diaphragm 22. Therefore, even when the rotating shaft of the compressor is driven for rotation by the engine, the compressor is operated at the minimum displacement.

Next, a description will be given of the operation of the control valve performed when the compressor is started.

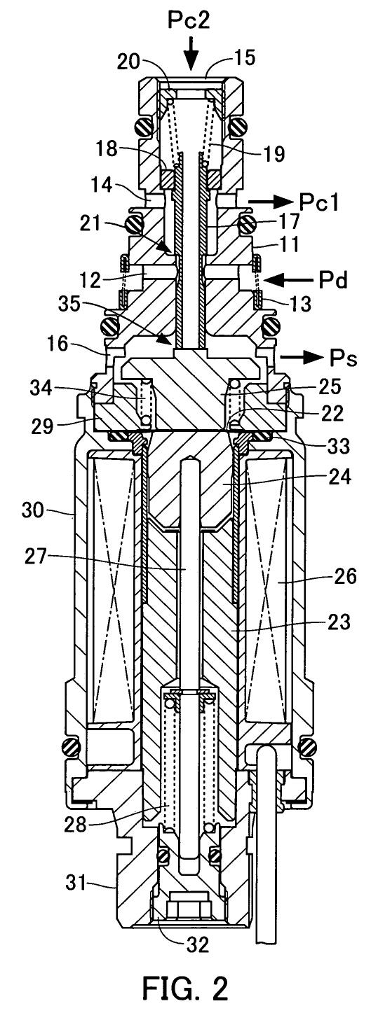

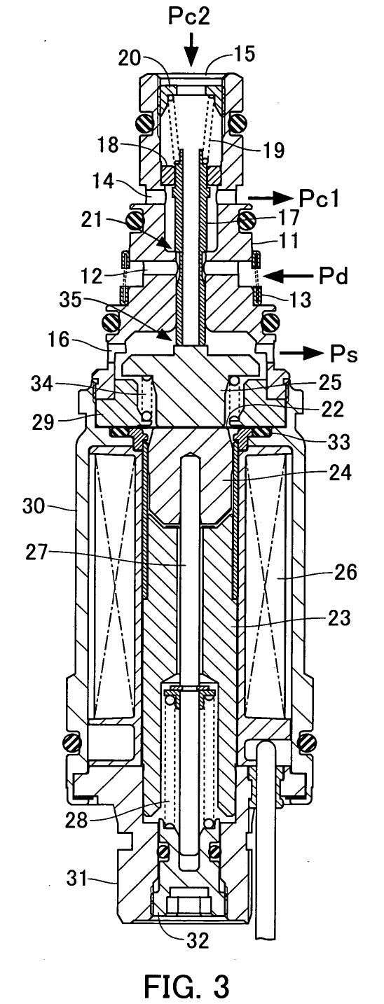

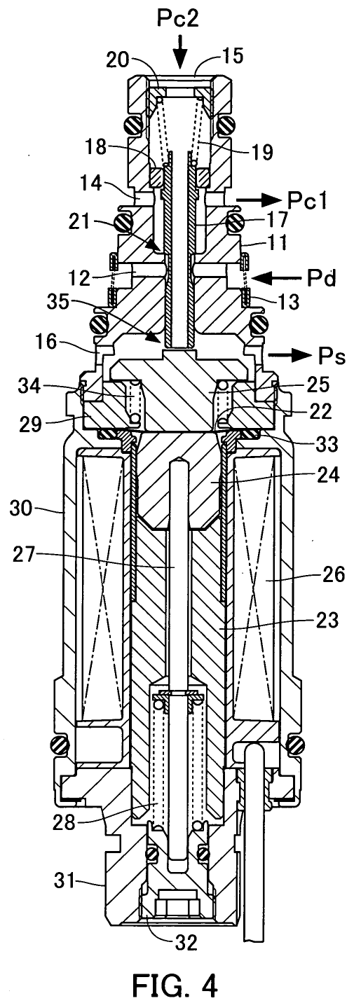

FIG. 2 is a central longitudinal cross-sectional view of the control valve according to the first embodiment, in a state immediately after the start of energization of the solenoid. FIG. 3 is a central longitudinal cross-sectional view of the control valve according to the first embodiment, in a state where the first control valve is fully closed. FIG. 4 is a central longitudinal cross-sectional view of the control valve according to the first embodiment, in a state where the second control valve is fully opened.

In the control valve, the case 30, the annular member 29, the second plunger 25, the first plunger 24, the core 23, and the handle 31 are made of magnetic materials, and the magnetic lines of flux generated by the coil 26 extend through a magnetic circuit formed by these magnetic parts. First, when the control current starts to be supplied to the coil 26 of the solenoid as in the case of the compressor being started, and reaches a certain value, the first plunger 24 is attracted to the second plunger 25, as shown in FIG. 2, and magnetically coupled to the second plunger 25 via the diaphragm 22. Thereafter, the first plunger 24 and the second plunger 25 operate in unison to behave as one plunger.

Further, as the control current is increased, the core 23 attracts the first plunger 24, and the first plunger 24 and the second plunger 25 integrally coupled with each other are pulled downward, as viewed in FIG. 2. In a manner following the motion of these plungers 24 and 25, the hollow cylindrical member 17 is pushed downward by the urging force of the spring 19, which places the first control valve 21 in the fully-closed state, as shown in FIG. 3. At this time, the second control valve 35 remains fully closed.

When the core 23 further attracts the first plunger 24, the first plunger 24 and the second plunger 25 integrally coupled with each other continue to be pulled downward, as viewed in FIG. 3, but the hollow cylindrical member 17 is not pushed downward any further, as viewed in FIG. 3, due to the fully-closed state of the first control valve 21. Therefore, the second plunger 25 is pulled away from the hollow cylindrical member 17 to cause the second control valve 35 to start to open, and when the first plunger 24 is attracted to the core 23, the second control valve 35 fully opens. This promptly shifts the compressor to the maximum displacement operation.

When the compressor continues to be operated at the maximum displacement to make suction pressure Ps in the suction chamber low enough, the diaphragm 22 senses suction pressure Ps which has lowered and is about to be displaced upward. At this time, if the control current supplied to the coil 26 is reduced to a value corresponding to the set point of air conditioning, the first plunger 24, the diaphragm 22, and the second plunger 25 in a state attracted to each other move upward, as viewed in FIG. 4, in unison to a position where suction pressure Ps, the loads of the springs 19, 28, and 34, and the attractive force of the solenoid are balanced. In the balanced state, the first control valve 21 and the second control valve 35 are closed to hold pressure Pc in the crankcase at a constant level, whereby the compressor maintains the operation at displacement corresponding to the control current.

If the engine speed drops or the refrigeration load increases when the control valve is in the balanced state, suction pressure Ps rises so that the diaphragm 22 is displaced downward as viewed in FIG. 4. This causes the second control valve 35 to open to lower pressure Pc in the crankcase, so that the compressor operates to increase the displacement thereof. On the other hand, if the engine speed rises or the refrigeration load decreases when the control valve in the balanced state, suction pressure Ps lowers so that the diaphragm 22 is displaced upward, as viewed in FIG. 4, to push the hollow cylindrical member 17 upward to open the first control valve 21. This causes pressure Pc in the crankcase to rise, so that the compressor operates to decrease the displacement thereof. As a result, the compressor has pressure Pc in the crankcase controlled such that pressure Ps becomes equal to a value set by the control current of the solenoid.

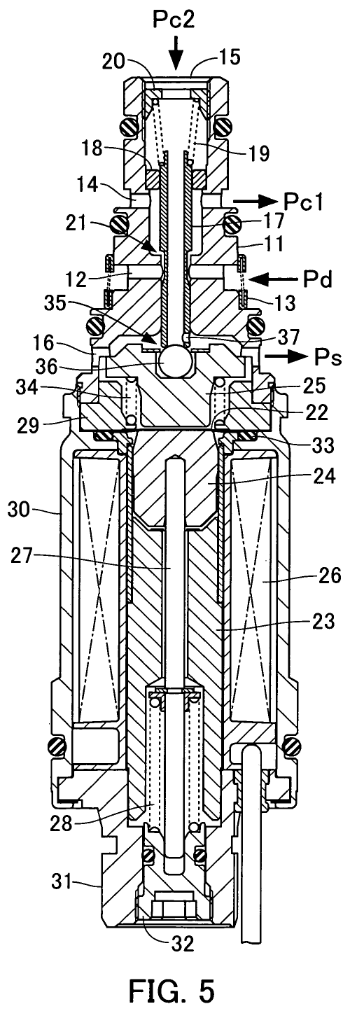

FIG. 5 is a central longitudinal cross-sectional view of the arrangement of a control valve for a variable displacement compressor, according to a second embodiment of the present invention. In FIG. 5, component elements identical to those shown in FIGS. 1 and 4 are designated by identical reference numerals, and detailed description thereof is omitted.

As is distinct from the control valve according to the first embodiment in which the second control valve 35 has a poppet valve structure, in the control valve according to the second embodiment, the second control valve 35 has a ball valve structure. More specifically, in the control valve according to the second embodiment, a recess is formed in a central part of the top of the second plunger 25, and a ball 36 is disposed in the recess, to form a valve element of the second control valve 35. With this configuration, when the second control valve 35 is in the fully-closed state, even if the second plunger 25 guided by the spring 34 is inclined with respect to its axis during the axial motion thereof, the second control valve 35 can be prevented from leakage of refrigerant due to constant contact between the valve element of the ball 36 and the valve seat of the end face of the hollow cylindrical member 17.

Further, the control valve includes an orifice 37 which is formed in the hollow cylindrical member 17 at a location close to the end face thereof forming the valve seat, in a manner bypassing the second control valve 35. This orifice 37 is provided for increasing the amount of extracted refrigerant, in view of the balance between the amount of refrigerant supplied to the crankcase via the first control valve 21 and the amount of refrigerant delivered from the crankcase via the second control valve 35. Therefore, the orifice 37 may be formed in the hollow cylindrical member 17 of the control valve according to the first embodiment, as required.

The operation of the control valve according to the second embodiment is the same as that of the control valve according to the first embodiment, and hence detailed description thereof is omitted.

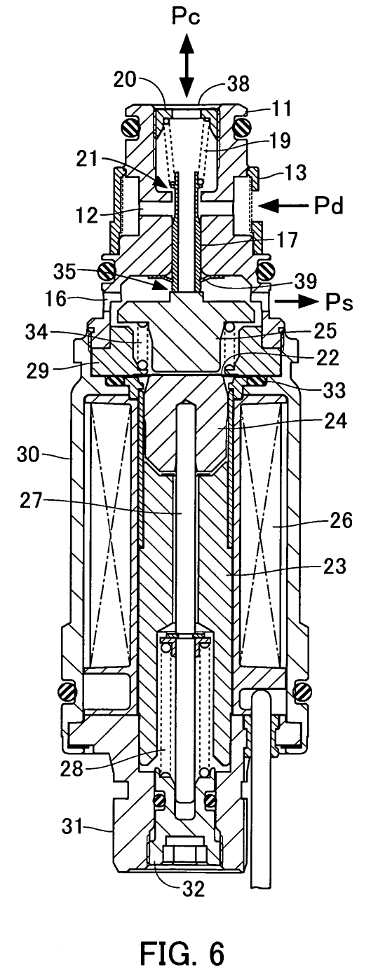

FIG. 6 is a central longitudinal cross-sectional view of the arrangement of a control valve for a variable displacement compressor, according to a third embodiment of the present invention. In FIG. 6, component elements identical to those shown in FIGS. 1 to 4 are designated by identical reference numerals, and detailed description thereof is omitted.

As is distinct from the control valves according to the first and second embodiments, in which the port 14 dedicated to delivery of pressure Pc1 to the crankcase and the port 15 dedicated to introduction of pressure Pc2 from the crankcase are provided, in the control valve according to the third embodiment, the number of ports leading to the crankcase is reduced to one, to thereby form a shared structure. More specifically, in the control valve according to the third embodiment, a port 38 is formed in the top of the body 11, as viewed in FIG. 6, for communication with the crankcase of the compressor to supply and extract pressure Pc to and from the crankcase, and the first control valve 21 is formed between the port 38 and the port 12 at discharge pressure Pd. Further, the hollow cylindrical member 17 is provided with a stopper 39 circumferentially attached on the outer periphery thereof at a location close to the lower end thereof, as viewed in FIG. 6, whereby the lift position of the first control valve 21 in the fully-open state thereof is limited.

The operation of the control valve according to the third embodiment is the same as those of the control valves according to the first and second embodiments, and hence detailed description thereof is omitted.

The control valve for a variable displacement compressor, according to the present invention, is configured such that essential component parts of the first and second control valves are formed by one hollow cylindrical member, and hence the first and second control valves can be simplified in construction, which is advantageous in reducing the costs of parts and the manufacturing cost of the control valve.

Further, the control valve according to the present invention operates such that after one of the first and second control valves closes, the other starts to open, and hence during the operation of the compressor, one of the first and second control valves is necessarily closed. Therefore, when refrigerant is introduced into the crankcase, the second control valve toward the suction chamber is closed, and when refrigerant is extracted therefrom, the first control valve toward the discharge chamber is closed, which makes it possible to increase the speed of introduction and extraction of refrigerant, i.e. the speed of response of the control valve.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A control valve for a variable displacement compressor, including a first control valve that controls a flow rate of refrigerant flowing from a discharge chamber of the compressor to a crankcase of the compressor, a second control valve that controls a flow rate of refrigerant flowing from the crankcase to a suction chamber of the compressor, a pressure-sensing section that senses suction pressure in the suction chamber, and a solenoid that sets a set point of the pressure-sensing section by an external current supplied thereto, as desired, wherein the pressure-sensing section is disposed between a first plunger and a second plunger as divisional plungers of the solenoid, comprising:
a first port that receives discharge pressure from the discharge chamber;
a second port that is disposed on a side of the first port opposite from the solenoid, for communication with the crankcase;
a third port that is disposed on a side of the first port toward the solenoid, for communication with the suction chamber; and
a hollow cylindrical member that is disposed in a manner such that the hollow cylindrical member is movable back and forth along an axis of the solenoid, the hollow cylindrical member having one end opening in the second port, and another end opening in the third port, an opening of the other end being opened and closed by the second plunger which is disposed between the hollow cylindrical member and the pressure-sensing section and is urged in a direction away from the pressure-sensing section,
wherein the hollow cylindrical member is configured such that a refrigerant passage which is formed between the first port and the second port and through which extends the hollow cylindrical member, to form a valve hole, and a large-diameter portion of the hollow cylindrical member which is positioned within the second port and formed to have a larger outer diameter than an inner diameter of the refrigerant passage, form the first control valve, and an end face of the other end and the second plunger form the second control valve.

2. The control valve according to claim 1, wherein a space communicating with the second port is divided into two by a bearing part that supports the hollow cylindrical member on a side toward the one end such that the hollow cylindrical member is movable back and forth, the control valve comprising a fourth port for communication between one divisional space formed between the bearing part and the first control valve and the crankcase.

3. The control valve according to claim 1, wherein the second plunger has a surface opposed to the end face of the other end of the hollow cylindrical member, formed such that the surface is flat, and the second control valve is formed to have a poppet valve structure.

4. The control valve according to claim 1, wherein the second plunger has a ball disposed at a location opposed to the end face of the other end of the hollow cylindrical member, whereby the second control valve is formed to have a ball valve structure.

5. The control valve according to claim 1, wherein the hollow cylindrical member has an orifice bypassing the second control valve.
